(19) United States
(12) Patent Application Publication
(10) Pub. No.: US 2025/0231394 A1
(43) Pub. Date: Jul. 17, 2025

(54) ENDOSCOPE APPARATUS

(71) Applicant: Longjie SUN, Shenzhen (CN)

(72) Inventor: Longjie SUN, Shenzhen (CN)

(21) Appl. No.: 18/430,292

(22) Filed: Feb. 1, 2024

(30) Foreign Application Priority Data
Jan. 16, 2024 (CN) 202420107683.X

(51) Int. Cl. G02B 23/24

(52) U.S. Cl. CPC G02B 23/2484; G02B 23/2446

(57) ABSTRACT

Provided is an endoscope apparatus, including: a main display machine, a connecting line and an endoscope lens, where one end of the connecting line is connected to the main display machine, and the other end of the connecting line is connected to the endoscope lens. The endoscope lens includes a main body shell, a camera mounted at one end of the main body shell, several LED lamps and infrared lamps arranged around the camera at equal intervals, and an infrared filter mounted on the camera. The camera, the LED lamps and the infrared lamps are connected to the main display machine through the connecting line.

### CROSS REFERENCE TO RELATED APPLICATION

This application claims priority benefit of Chinese Patent Application No. 202420107683. X, filed on Jan. 16, 2024, and the entire contents of which are incorporated herein by reference.

### TECHNICAL FIELD

The present disclosure relates to the technical field of endoscopes, and in particular to an endoscope apparatus.

### BACKGROUND

An endoscope is a detection instrument that integrates traditional optics, ergonomics, precision machinery, mathematics and software. The endoscope has an image sensor, an optical lens, a light source for illumination and a mechanical apparatus. However, the existing endoscope does not have a night vision function, and can be used only under the conditions of natural light or auxiliary lighting of LED visible light. However, the LED visible light is not suitable in some extreme environments. For example, a beekeeper, an outdoor explorer and an animal scientist, they need to observe beehives and animal nests without disturbing animals. The LED visible light is easy to scare animals due to excessively strong light.

### SUMMARY

Based on this, it is necessary to provide an endoscope apparatus with a night vision function and high practicability in view of the problems in an existing endoscope.

An endoscope apparatus includes a main display machine, a connecting line and an endoscope lens, where one end of the connecting line is connected to the main display machine, and the other end of the connecting line is connected to the endoscope lens; the endoscope lens includes a main body shell, a camera mounted at one end of the main body shell, several LED lamps and infrared lamps arranged around the camera at equal intervals, and an infrared filter mounted on the camera; and the camera, the LED lamps and the infrared lamps are connected to the main display machine through the connecting line.

The endoscope apparatus is provided with the several LED lamps and infrared lamps arranged around the camera at equal intervals, and the infrared filter mounted on the camera, so during use, the camera can achieve a night vision effect through the cooperation of the infrared lamps and the infrared filter, and the endoscope apparatus is very practical and suitable for requirements of many extreme environments.

In one of the embodiments, the endoscope lens further includes a sealing lens mounted on the main body shell, and the sealing lens and the camera are arranged oppositely.

In one of the embodiments, the endoscope apparatus further includes a first clamping ring and a second clamping ring which are arranged on the camera, and the infrared filter is clamped between the first clamping ring and the second clamping ring.

In one of the embodiments, the main body shell is arranged in a cylindrical shape.

In one of the embodiments, a display screen and a mode switching button are mounted on the main display machine, and the mode switching button is capable of being switched between an infrared mode and a normal mode.

In one of the embodiments, a brightness adjusting button is further mounted on the main display machine, and the brightness adjusting button is electrically connected to the LED lamps.

In one of the embodiments, a control button is further mounted on the main display machine, and the control button is electrically connected to the display screen and the camera.

In one of the embodiments, the endoscope apparatus further includes a multifunctional bracket, and one end of the multifunctional bracket is connected to the main display machine.

In one of the embodiments, the back of the main display machine is provided with a screw hole, a screw stud is mounted at one end of the multifunctional bracket, and the screw stud is adapted to the screw hole.

In one of the embodiments, a bump is mounted at the other end of the multifunctional bracket.

### BRIEF DESCRIPTION OF DRAWINGS

The drawings of the specification that constitute a part of the present application are used to provide a further understanding of the present disclosure. The exemplary embodiments of the present disclosure and the description thereof are used to explain the present disclosure, and do not constitute an improper limitation of the present disclosure. In the drawings:

FIG. 1 is a schematic diagram of an endoscope apparatus according to the present disclosure;

FIG. 2 is a schematic diagram of an endoscope lens in the endoscope apparatus shown in FIG. 1;

FIG. 3 is a schematic exploded view of the endoscope lens shown in FIG. 2;

FIG. 4 is a schematic diagram of a main display machine and a multifunctional bracket in an endoscope apparatus; and

FIG. 5 is a schematic diagram of an endoscope apparatus wound and fixed by a multifunctional bracket.

### DETAILED DESCRIPTION OF THE EMBODIMENTS

To facilitate understanding of the present disclosure, the present disclosure will be described more comprehensively below with reference to related drawings. Preferred embodiments of the present disclosure are provided in the drawings. However, the present disclosure may be implemented in various forms, and is not limited to the embodiments herein. On the contrary, these embodiments are provided for a more thorough and comprehensive understanding of the content disclosed in the present disclosure.

It should be noted that when an element is expressed as “fixed to” another element, it may be directly located on another element, or there may be an intermediate element. When an element is expressed as “connected to” another element, it may be directly connected to another element, or there may be an intermediate element at the same time. In addition, the term “and/or” herein is only intended to describe association relationships of related objects, and indicates that there may be three relationships, for example, the expression of “A and/or B” may indicate the following three conditions: A exists separately, A and B exist at the same time, and B exists separately.

Unless otherwise defined, all technical and scientific terms used herein have the same meanings as those generally understood by those skilled in the art of the present disclosure. The terms used in the description of the present disclosure herein are only for describing particular embodiments, for example, “inner”, “outer”, “left”, “right” and similar expressions are only for illustration, and are not intended to limit the present disclosure.

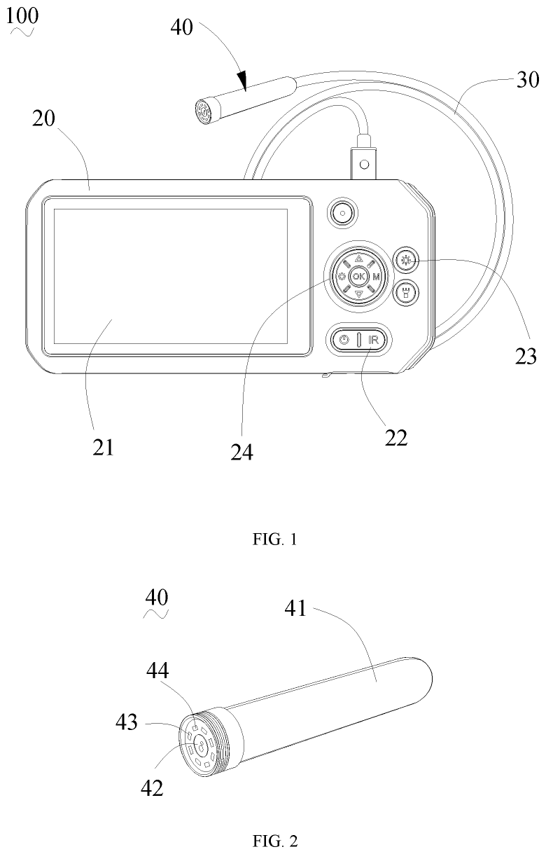

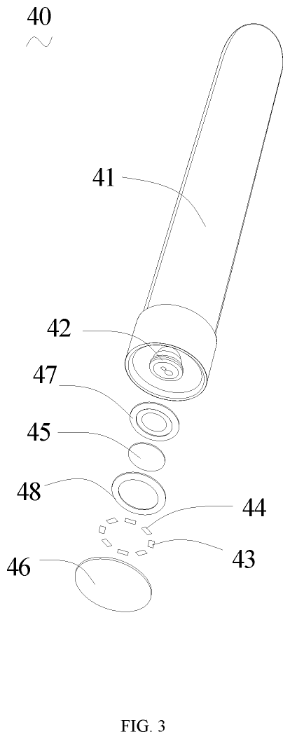

Referring to FIG. 1 to FIG. 3, they are an endoscope apparatus 100 according to the present disclosure, including a main display machine 20, a connecting line 30 and an endoscope lens 40, where one end of the connecting line is connected to the main display machine 20, and the other end of the connecting line 30 is connected to the endoscope lens. The endoscope lens 40 includes a main body shell 41, a camera 42 mounted at one end of the main body shell 41, a plurality of LED lamps 43 and infrared lamps 44 arranged around the camera 42 at equal intervals, and an infrared filter 45 mounted on the camera 42. The camera 42, the LED lamps 43 and the infrared lamps 44 are connected to the main display machine 20 through the connecting line. In this embodiment, the number of the LED lamps 43 and the number of the infrared lamps 44 are four, and the four LED lamps 43 and the four infrared lamps 44 are alternately arranged.

In this embodiment, a diameter of the camera 42 is about 8.5 mm, so that it is convenient for the camera to go deep into a small hole or machinery for inspection and flaw detection.

Further, a display screen 21 and a mode switching button 22 are mounted on the main display machine 20, and the mode switching button 22 may be switched between an infrared mode and a normal mode to independently control the LED lamps 43 and the infrared lamps 44 to operate. To adjust the brightness of the LED lamps 43 conveniently, a brightness adjusting button 23 is further mounted on the main display machine 20, and the brightness adjusting button 23 is electrically connected to the LED lamps 43. Furthermore, a control button 24 is further mounted on the main display machine 20, and the control button 24 is electrically connected to the display screen 21 and the camera 42 so as to control the display screen 21 and the camera 42 to work.

Further, the endoscope lens 40 further includes a sealing lens 46 mounted on the main body shell 41, and the sealing lens 46 and the camera 42 are arranged oppositely, thereby protecting and sealing the camera 42 and preventing external dust from entering and affecting the camera 42. Furthermore, the endoscope lens 40 further includes a first clamping ring 47 and a second clamping ring 48 which are mounted on the camera 42, and the infrared filter 45 is clamped between the first clamping ring 47 and the second clamping ring 48, so that the infrared filter 45 is convenient to mount and dismount. The main body shell 41 is arranged in a cylindrical shape, so that it is convenient for the main body shell to be inserted into a gap for detection.

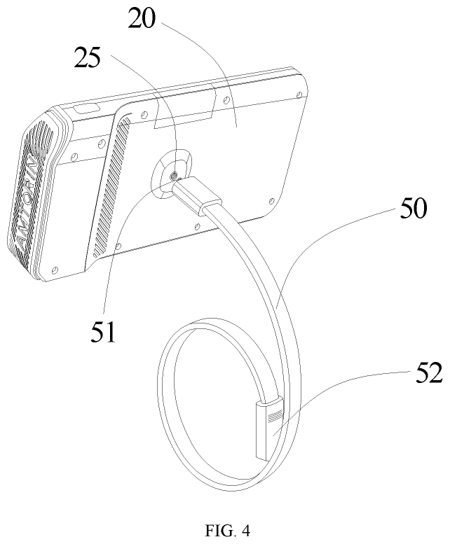

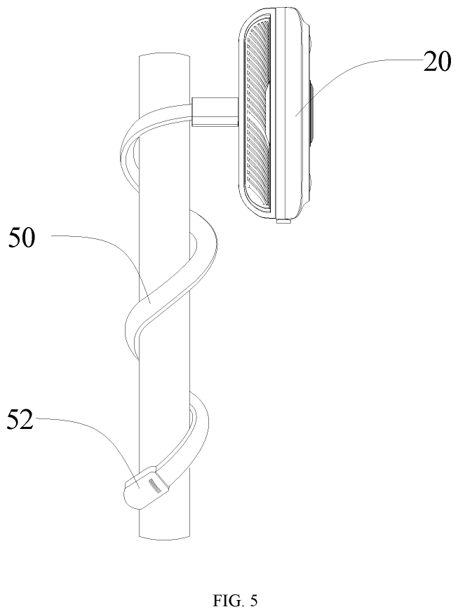

Referring to FIG. 4 and FIG. 5, they are a local schematic diagram of another embodiment of an endoscope apparatus 100 according to the present disclosure. The endoscope apparatus 100 further includes a multifunctional bracket 50, one end of the multifunctional bracket is connected to the main display machine 20, and the endoscope apparatus can be wound on a supporting rod through the multifunctional bracket 50 under the condition of inconvenient handheld operation, so that the whole endoscope apparatus 100 can be fixed and hands are liberated. Furthermore, the multifunctional bracket 50 may support the main display machine 20 to serve as a bracket, so that the endoscope apparatus 100 can be placed on a horizontal plane. Furthermore, the back of the main display machine 20 is provided with a screw hole 25, a screw stud 51 is mounted at one end of the multifunctional bracket 50, and the screw stud 51 is adapted to the screw hole 25, so that the multifunctional bracket 50 can be rapidly disassembled and assembled through the screw stud 51 and the screw hole 25. To facilitate the stress during the winding operation of the multifunctional bracket 50, a bump 52 is arranged at the other end of the multifunctional bracket 50. The multifunctional bracket 50 may be a universal hose, or may be other structural members, as long as bending deformation and fixation can be realized.

The endoscope apparatus 100 is provided with the several LED lamps 43 and infrared lamps 44 arranged around the camera 42 at equal intervals, and the infrared filter 45 mounted on the camera 42, so during use, the camera can achieve a night vision effect through the cooperation of the infrared lamps 44 and the infrared filter 45, and the endoscope apparatus is very practical and suitable for requirements of many extreme environments.

After the endoscope apparatus 100 is started through a power button, the LED lamps 43 in the endoscope apparatus 40 will be lightened, and the display screen 21 will display an image. When an infrared night vision mode is required, the infrared lamps 44 can be switched to the infrared night vision mode to work by pressing the mode switching button 22. In this mode, normal use can be achieved without the help of the visible light such as the LED lamps 43, and the infrared night vision mode can be exited by pressing the mode switching button 22 again. After the multifunctional bracket 50 and the main display machine 20 are fixed, the shape and angle of the multifunctional bracket 50 can be manually adjusted so as to be suspended or wound on a column, a hook and other objects.

The technical features of the above embodiments can be combined arbitrarily. To simplify the description, possible combinations of the technical features of the above embodiments are not completely described. However, as long as there is no contradiction between the combinations of these technical features, the combinations should be considered to fall within the scope of the present specification.

The above embodiments only express several embodiments of the present disclosure, and specific and detailed descriptions thereof are provided. However, these embodiments cannot be understood as limitations on the scope of the patent of the present disclosure. It should be pointed out that for those of ordinary skill in the art, several modifications and improvements can be made without departing from the idea of the present disclosure, and all these modifications and improvements should fall within the scope of protection of the present disclosure. Therefore, the protection scope of the patent of the present disclosure should be subject to the claims.

What is claimed is:

1. An endoscope apparatus, comprising: a main display machine, a connecting line and an endoscope lens, wherein one end of the connecting line is connected to the main display machine, and the other end of the connecting line is connected to the endoscope lens; the endoscope lens comprises a main body shell, a camera mounted at one end of the main body shell, several LED lamps and infrared lamps arranged around the camera at equal intervals, and an infrared filter mounted on the camera; and the camera, the LED lamps and the infrared lamps are connected to the main display machine through the connecting line.

2. The endoscope apparatus according to claim 1, wherein the endoscope lens further comprises a sealing lens mounted on the main body shell, and the sealing lens and the camera are arranged oppositely.

3. The endoscope apparatus according to claim 1, further comprising a first clamping ring and a second clamping ring which are arranged on the camera, and the infrared filter is clamped between the first clamping ring and the second clamping ring.

4. The endoscope apparatus according to claim 1, wherein the main body shell is arranged in a cylindrical shape.

5. The endoscope apparatus according to claim 1, wherein a display screen and a mode switching button are mounted on the main display machine, and the mode switching button is capable of being switched between an infrared mode and a normal mode.

6. The endoscope apparatus according to claim 5, wherein a brightness adjusting button is further mounted on the main display machine, and the brightness adjusting button is electrically connected to the LED lamps.

7. The endoscope apparatus according to claim 5, wherein a control button is further mounted on the main display machine, and the control button is electrically connected to the display screen and the camera.

8. The endoscope apparatus according to claim 1, further comprising a multifunctional bracket, wherein one end of the multifunctional bracket is connected to the main display machine.

9. The endoscope apparatus according to claim 8, wherein the back of the main display machine is provided with a screw hole, a screw stud is mounted at one end of the multifunctional bracket, and the screw stud is adapted to the screw hole.

10. The endoscope apparatus according to claim 9, wherein a bump is mounted at the other end of the multifunctional bracket.
